(19) United States
(12) Patent Application Publication
(10) Pub. No.: US 2008/0158270 A1
(43) Pub. Date: Jul. 3, 2008

(54) PRINT CONTROL APPARATUS, PRINT SYSTEM, AND COMPUTER-READABLE RECORDING MEDIUM CONTAINING PRINT CONTROL PROGRAM

(75) Inventor: Masayuki Ishibashi, Hekinan-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/965,029

(22) Filed: Dec. 27, 2007

(30) Foreign Application Priority Data
Dec. 28, 2006 (JP) 2006354145

(51) Int. Cl. B41J 2/195

(52) U.S. Cl. 347/7

(57) ABSTRACT

A print control apparatus which is connected to a print device for printing an image by fixing ink on a recording paper and which controls the print device, including: a paper-type identifying portion which identifies a type of the recording paper on which the print device prints the image, on the basis of at least one of an input operation by an operator and pre-set contents; and an ink determining portion which determines ink to be used by the print device in order to print the image on the recording paper that is identified by the paper-type identifying portion, on the basis of ink fixation information which indicates a level of ink fixation and which is inputted by the input operation by the operator.

### CROSS REFERENCE TO RELATED APPLICATION

The present application claims priority from Japanese Patent Application No. 2006-354145, which was filed on Dec. 28, 2006, the disclosure of which is herein incorporated by reference in its entirety.

### BACKGROUND OF THE INVENTION

1. Field of the Invention

The present invention relates to a print control apparatus for controlling a print device to print an image by fixing ink on a recording paper, a print system including the print control apparatus and the print device, and a computer-readable recording medium containing a print control program for controlling the print device.

2. Discussion of Related Art

In a print system as disclosed in Japanese Patent Application Publication No. 2004-50504, for instance, inks to be used in printing are determined from among predetermined ink sets, on the basis of a type of recording papers such as plain papers and glossy papers.

The ink sets include a combination of only pigment inks, a combination of only dye inks, a combination of a part of the pigment inks and a part of the dye inks, and a combination of all of the pigment inks and all of the dye inks.

### SUMMARY OF THE INVENTION

The quality of the recording papers differs from manufacturer to manufacturer. Accordingly, even if the recording papers belong to the same kind, e.g., even if the recording papers are the plain papers, there may be a subtle difference in compatibility with ink among the recording papers. Therefore, in the print system disclosed in the above-indicated Publication wherein the inks to be used in printing are determined on the basis of the type of the recording papers, even if the recording papers of the same kind are used, there may be generated a difference in an ink fixation property among the recording papers of the same kind where the recording papers are produced mutually different manufacturers. In this instance, there may be a risk that an intended print result desired by a user cannot be obtained.

It is therefore an object of the present invention to ensure that an intended print result desired by a user can be obtained without being influenced by the quality of the recording papers to be used.

The object indicated above may be attained according to a first aspect of the invention, which provides a print control apparatus which is connected to a print device for printing an image by fixing ink on a recording paper and which controls the print device. The print control apparatus comprises: a paper-type identifying portion which identifies a type of the recording paper on which the print device prints the image, on the basis of at least one of an input operation by an operator and pre-set contents; and an ink determining portion which determines ink to be used by the print device in order to print the image on the recording paper that is identified by the paper-type identifying portion, on the basis of ink fixation information which indicates a level of ink fixation and which is inputted by the input operation by the operator.

The object indicated above may also be attained according to a second aspect of the invention, which provides a print system comprising a print device which prints an image by fixing ink on a recording paper and a print control apparatus which controls the print device, wherein the print control apparatus includes: (a) a paper-type identifying portion which identifies a type of the recording paper on which the print device prints the image, on the basis of at least one of an input operation by an operator and pre-set contents; and (b) an ink determining portion which determines ink to be used by the print device in order to print the image on the recording paper that is identified by the paper-type identifying portion, on the basis of ink fixation information which indicates a level of ink fixation and which is inputted by the input operation by the operator.

The object indicated above may also be attained according to a third aspect of the invention, which provides a computer-readable recording medium containing a print control program for controlling a print device which prints an image by fixing ink on a recording paper, the print control program causing a computer to function such that the computer includes: a paper-type identifying portion which identifies a type of the recording paper on which the print device prints the image, on the basis of at least one of an input operation by an operator and pre-set contents; and an ink determining portion which determines ink to be used by the print device in order to print the image on the recording paper that is identified by the paper-type identifying portion, on the basis of ink fixation information which indicates a level of ink fixation and which is inputted by the input operation by the operator.

The above-indicated ink fixation information includes information that directly or indirectly indicates the fixation property of the ink which is considered by the user that the print device should use in printing or use of which is desired by the user. More specifically explained, the ink fixation information includes a degree of ease with which the ink dries, for instance. Further, where a plurality of inks have mutually different ink fixation properties in a case in which the print device is configured to selectively use the plurality of inks, a name of any of the plurality of inks, that is, a type or kind of any of the plurality of inks, can be considered as one sort of the ink fixation information. In addition, in a case in which the print device is configured to use a mixture ink in which the plurality of inks having mutually different ink fixation properties are to be mixed, a mixing ratio of the mixture ink at which the plurality of inks are to be mixed can be considered as one sort of the ink fixation information. “Mixture ink” may be defined as inks which are mixed in advance before attaching to the recording paper or may be defined as inks being mixed on the recording paper as a result of attaching to the recording paper individually.

According to the first through third aspects of the invention, the user can set the level of the ink fixation depending upon the type of the recording paper to be used, so that the level of the ink fixation can be suitably changed or adjusted. Accordingly, it is possible to obtain an intended print result desired by the user, irrespective of the characteristics of the recording paper such as the paper quality.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a schematic view showing a print system according to a first embodiment of the invention;

FIG. 2 is an explanatory view of a print setting window in the first embodiment;

FIG. 3 is a flow chart showing characteristic operations of a printer by execution of a program for controlling the printer in the first embodiment:

FIG. 4 is an explanatory view of a fixation-level setting section in the first embodiment;

FIG. 5 is a schematic view showing a print system according to a second embodiment of the invention;

FIG. 6 is an explanatory view of a print setting window in the second embodiment;

FIG. 7 is an explanatory view of a detailed setting window for the fixation level in the second embodiment;

FIG. 8 is an explanatory view of an advice window in the second embodiment;

FIG. 9 is a flow chart showing characteristic operations of a printer by execution of a program for controlling the printer in the second embodiment:

FIG. 10 is a flow chart showing fixation-level setting processing in the second embodiment;

FIG. 11 is an explanatory view of an error message window in the second embodiment; and

FIGS. 12 and 13 are flow charts showing fixation-level detailed setting processing in the second embodiment.

### DETAILED DESCRIPTION OF THE PREFERRED EMBODIMENTS

There will be hereinafter described embodiments of the invention with reference to the drawings. In each of the following embodiments, a print control program according to the invention is incorporated in or installed on a computer that is connected to a printer, and the computer and the printer function as a print system.

### First Embodiment

### 1. Outline of Print System

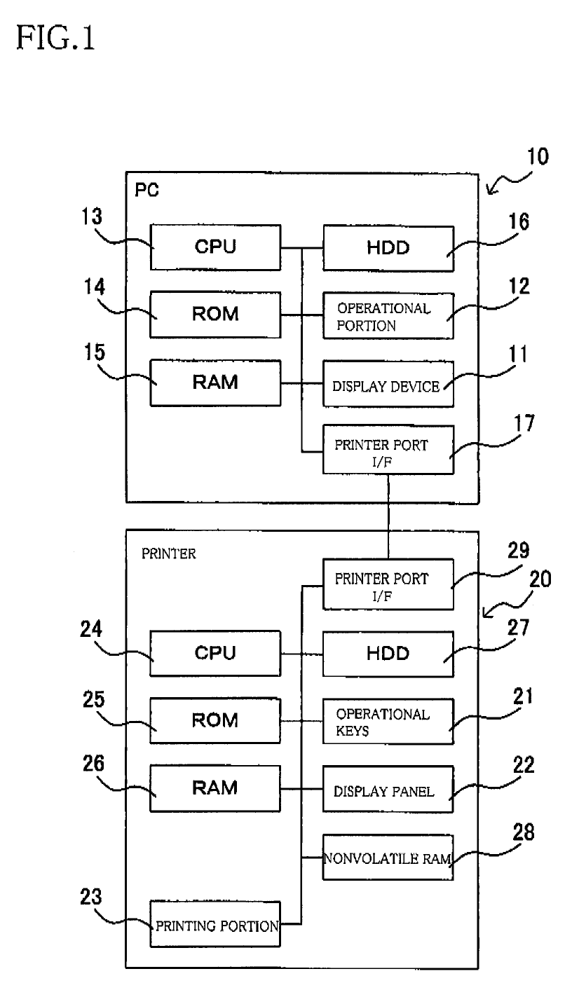

FIG. 1 is a view showing an outline of a print system according to a first embodiment of the invention. The print system is constituted by including a computer 10, a printer 20, and so on. In the following explanation, the computer 10 is referred to as “PC 10”.

As shown in FIG. 1, the PC 10 includes: a display device 11 constituted by a liquid crystal display (LCD), a cathode ray tube (CRT), or the like, for displaying images and characters; an operational portion 12 constituted by a keyboard (not shown) and a mouse (not shown) serving as pointing means for moving a pointer (not shown) which points an arbitrary portion on the display device 11; a central processing unit (CPU) 13; a read-only memory (ROM) 14; a random-access memory (RAM) 15; a hard disk drive (HDD) 16; and a printer port interface (I/F) 17 to which a printer 20 is to be connected.

The printer 20 in the present embodiment is a known ink-jet recording device configured to form an image on a recording paper by ejecting ink as droplets toward the recording paper. The printer 20 has: a pigment-ink-tank group (not shown) constituted by a plurality of pigment-ink tanks (four pigment-ink tanks in the present embodiment) in which are stored mutually different colors of pigment inks; and a dye-ink-tank group (not shown) constituted by a plurality of dye-ink tanks (four dye-ink tanks in the present embodiment) in which are stored mutually different colors of dye inks each having a higher degree of the ink fixation property than the pigment inks.

The printer 20 performs printing by ejecting the inks stored in the pigment-ink tanks and in the dye-ink tanks toward the recording paper, so that an image is formed on the recording paper.

The pigment-ink-tank group is constituted by including a black (Bk) pigment ink tank which stores black pigment ink, a cyan (C) pigment ink tank which stores cyan pigment ink, a yellow (Y) pigment ink tank which stores yellow pigment ink, and a magenta (M) pigment ink tank which stores magenta pigment ink. The dye-ink-tank group is constituted by including a black (Bk) dye ink tank which stores black dye ink, a cyan (C) dye ink tank which stores cyan dye ink, a yellow (Y) dye ink tank which stores yellow dye ink, and a magenta (M) dye ink tank which stores magenta dye ink. In the following description, the pigment inks and the dye inks are collectively referred to as “pigment ink” and “dye ink”, respectively, where the individual ink colors need not be distinguished from each other.

As shown in FIG. 1, the printer 20 includes operational keys 21 for selecting functions of the printer 20, a display panel 22 for displaying details of operations and working states, a printing portion 23 for printing characters, images, etc., on a recording medium such as the recording paper, a CPU 24, a ROM 25, a RAM 26, a HDD 27, a nonvolatile RAM 28 capable of maintaining memory contents stored therein even if a supply of electric power stops, a printer port interface 29 for connecting the printer 20 directly to the PC 10.

### 2. Print Setting Window 30

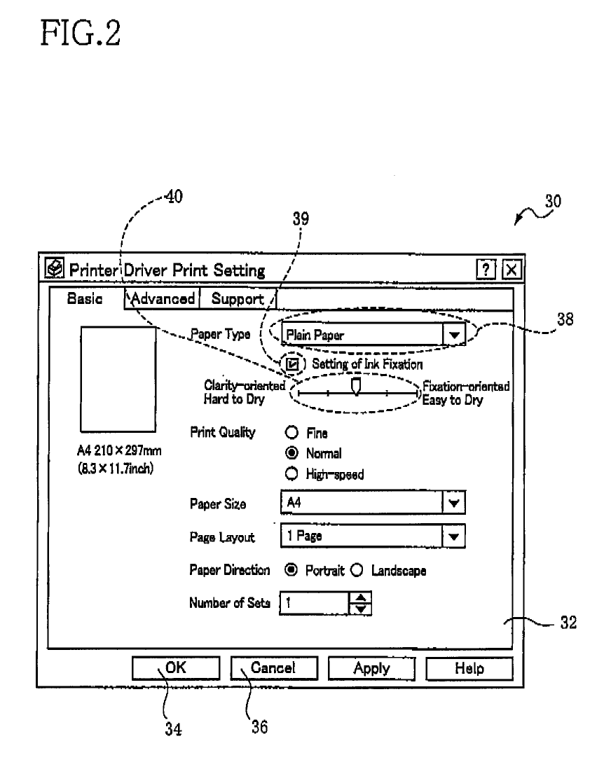

A user performs settings for printing an image to be printed (hereinafter referred to as “to-be-printed image” where appropriate) through a print setting window 30 shown in FIG. 2. The print setting window 30 is displayed on the display device 11 based on a program (i.e., a printer driver) explained below when a print setting command for performing the print settings with respect to the to-be-printed image is inputted by an operation of the user.

The print setting window 30 as an input-operation image is constituted by including a preference-setting inputting section 32, an “OK” button 34 for permitting execution of printing, and a “Cancel” button 36. The preference-setting inputting section 32 is for setting print setting items that relate to printing. The print setting items include a type (kind) of the recording paper such as the plain paper and the glossy paper, a level or degree of ink fixation (hereinafter referred to as “ink fixation level” or “fixation level” where appropriate), a size (dimensions) of the recording paper, and a number of sets for printing.

In the present embodiment, when the “OK” button 34 on the print setting window 30 is selected or clicked by the user, the to-be-printed image is printed according to contents of the print setting items inputted through the print setting window 30.

In each of the print setting items of the preference-setting inputting section 32 of the print setting window 30, a default value (initial set value) is set in advance. When the “OK” button 34 is selected without those items being changed by the user, the to-be-printed image is printed according to contents of the default values of the respective print setting items. The processing indicated above is carried out on the basis of the program (printer driver) which will be explained.

The values (contents) being set in the respective print setting items at a time when the printing of the to-be-printed image is performed are stored in the HDD 16 and the like, as default values of the respective print setting items in subsequent printing in order to update previously stored default values.

The preference-setting inputting section 32 is constituted by including a paper-type selecting section 38 for selecting or designating the type of the recording paper, a fixation-level-change selecting section 39 for selecting approval or non-approval for a change of setting in the ink fixation level, and a fixation-level setting section 40 for changing the ink fixation level.

The paper-type selecting section 38 is arranged such that the user can select the type of the recording paper to be used by the printer 20 in printing from among plain papers, ink-jet papers, glossy papers, postcards, overhead projector (OHP) films, and so on. For instance, the paper-type selecting section 38 is arranged to indicate names of plural types of recording papers in a pull-down menu for permitting the user to select arbitrary one of the plural types of recording papers.

The fixation-level-change selecting section 39 is arranged to approve the setting change in the ink fixation level when a check mark (✓) is placed in a check box of the fixation-level-change selecting section 39 and to prohibit the setting change in the ink fixation level when the check mark is not placed in the check box.

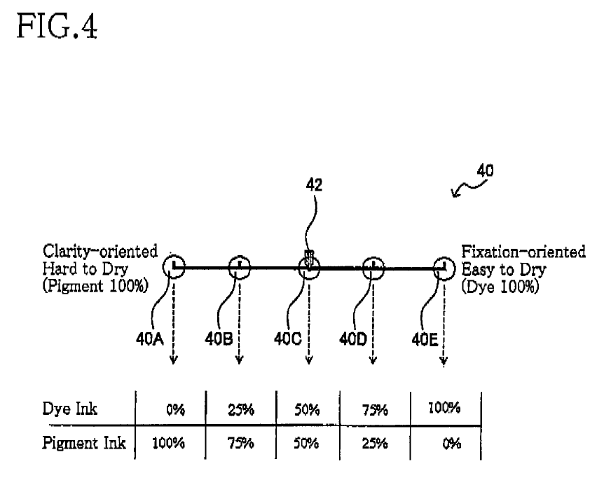

The fixation-level setting section 40 is arranged such that the user can select a level of the ink fixation from among a plurality of level steps (five level steps in the present embodiment). In the fixation-level setting section 40, the ink fixation level is indicated in the five level steps ranging from a fixation-oriented level to a clarity-oriented level. On the fixation-level setting section 40, there is provided a cursor 42 shown in FIG. 4 to be manipulated by the user such that the cursor 42 is movable to indicate an arbitrary one of the five level steps of the ink fixation desired by the user.

The fixation-level setting section 40 is arranged to accept the input operation by the user and to set, as the ink fixation level to be employed in printing, the ink fixation level corresponding to the position of the cursor 42 when the input operation by the user is actually conducted.

In the present embodiment, an increase in the ink fixation level means an increase in the degree of the ink fixation property. As the degree of the ink fixation property becomes higher, the ink which attached to the recording paper dries more easily.

In the present embodiment, the respective default values of the print setting items of the preference-setting inputting section 32 are determined as follows. That is, in the paper-type selecting section 38, “Plain Paper” is set as the default value. In the fixation-level-change selecting section 39, the default value is set so as to prohibit the setting change in the fixation level. In other words, the default value corresponds to a state in which the check mark is not placed in the check box of the fixation-level-change selecting section 39. In the fixation-level setting section 40, the fixation level step “3 (a median value)” is set as the default value.

### 2. Characteristic Operation of Printer by Execution of Print Control Program (Print System)

There will be next explained characteristic operations of the printer 20 when the program (printer driver) for controlling the printer 20 is executed in the PC 10.

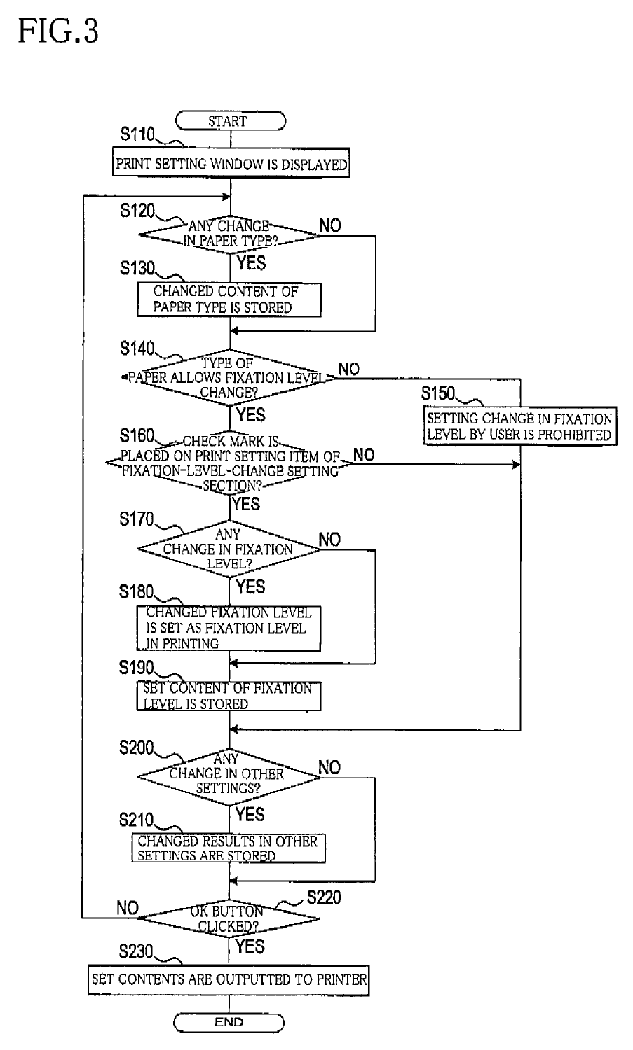

FIG. 3 is a flow chart indicating the characteristic operations by execution of the program for controlling the printer 20. This program is normally stored in the HDD 16 or the like and executed when a print command is inputted.

When the program shown in FIG. 3 is started, the print setting window 30 shown in FIG. 2 is displayed on the display device 11 (S110). In this instance, the default values stored in the HDD 16 are respectively inputted into the print setting items on the print setting window 30.

When the print setting window 30 is displayed on the display device 11 (S110), it is judged, on the basis of the value (content) inputted in the print setting item of the paper-type selecting section 38 shown in FIG. 2, whether there has been any change in the paper type (S120).

Where it is judged that there have been no changes in the paper type (S120: NO), it is judged whether the recording paper set at that time point, namely, the recording paper which is to be used in printing, corresponds to the type of the recording paper on which printing with the ink whose fixation level is arbitrarily set by the user is allowed to be performed (S140).

More specifically explained, where the type of the recording paper to be used in printing is the plain paper and the postcard, there is performed printing with the ink whose fixation level is set by the user. On the other hand, where the type of the recording paper to be used in printing is the ink-jet paper, the glossy paper and the OHP film, printing with the ink whose fixation level is set by the user is not allowed.

Where it is judged that there has been any change in the paper type (S120: YES), the value (type) being set in the print setting item of the paper-type selecting portion 38 is stored in the HDD 16 as a new default value so as to update the previously stored default value, and the value (type) is set as the type of the recording paper to be used in printing (S130). Subsequently, the control flow goes to S140.

Where it is judged in S140 that the recording paper to be used in printing corresponds to the type of the recording paper on which printing with the ink whose fixation level is set by the user is not allowed to be performed (S140: NO), the setting change in the ink fixation level by the user is prohibited (S150). In this instance, the ink fixation level determined in advance for the type of the recording paper that has been already set is set as the fixation level of the ink to be used in printing. Subsequently, it is judged whether there has been any change in other settings such as the size of the recording paper and the number of sets for printing (S200).

In the meantime, where it is judged in S140 that the recording paper to be used in printing corresponds to the type of the recording paper on which printing with the ink whose fixation level is set by the user is allowed to be performed (S140: YES), it is judged whether the check mark is placed on the print setting item (the check box) of the fixation-level-change setting section 39 shown in FIG. 2 (S160).

Where it is judged that the check mark is not placed on the print setting item of the fixation-level-change setting section 39 (S160: NO), the stored default value is set as the fixation level, and it is judged whether there has been any change in other settings such as the size of the recording paper and the number of sets for printing (S200).

Where it is judged that the check mark is placed on the print setting item of the fixation-level-change setting section 39 (S160: YES), the input operation by the user on the fixation-level setting section 40 shown in FIG. 2 is accepted, and it is judged whether the fixation level has been actually changed, namely, whether the position of the cursor 42 has been changed (S170).

Where it is judged that the fixation level has not been changed (S170: NO), the stored default value is set as the ink fixation level, and the thus set ink fixation level is stored in the HDD 16 as a new default value (S190).

On the other hand, where it is judged that the fixation level has been changed (S170: YES), the fixation level in accordance with the input operation by the user on the fixation-level setting section 40 is set as the fixation level of the ink to be used in printing (S180).

Here, the fixation-level setting section 40 will be described with reference to FIG. 4. As shown in FIG. 4, in a state in which the cursor 42 is located at a leftmost position 40A in the fixation-level setting section 40, the fixation level is set at “1”. In this case, the ink to be used in printing is determined to be only the pigment ink.

In a state in which the cursor 42 is located at a position 40B which is the second from the left, the fixation level is set at “2”. In this case, the ink to be used in printing is determined such that a mixing ratio of the dye ink and the pigment ink is equal to 1:3. In a state in which the cursor 42 is located at a position 40C which is the third from the left, namely, which is the middle, the fixation level is set at “3”. In this case, the ink to be used in printing is determined such that the mixing ratio of the dye ink and the pigment ink is equal to 1:1.

In a state in which the cursor 42 is located at a position 40D which is the fourth from the left, the fixation level is set at “4”. In this case, the ink to be used in printing is determined such that the mixing ratio of the dye ink and the pigment ink is equal to 3:1. In a state in which the cursor 42 is located at a position 40E which is the fifth from the left, the fixation level is set at “5”. In this case, the ink to be used in printing is determined to be only the dye ink.

When the fixation level is set in S180, the set fixation level is stored in the HDD 16 as a new default value (S190), and it is subsequently judged whether there has been any change in the other settings such as the size of the recording paper and the number of sets for printing (S200).

Where it is judged that there have been no changes in the other settings (S200: NO), it is judged whether the “OK” button 34 is selected or clicked (S220). On the other hand, where it is judged that there has been any change in the other settings (S200: YES), the results of change are stored in the HDD 16 as new default values (S210).

Where it is judged in S220 that the “OK” button 34 has not been selected (S220: NO), the control flow goes again to S120 to judge whether there has been any change in the type of the recording paper (S120). On the other hand, where it is judged that the “OK” button 34 has been selected (S220: YES), the contents of the print setting items set in the print setting window 30 during the present execution of the control are outputted to the printer 20 (S230), and the printer 20 performs printing in accordance with the contents. Thus, the execution of the program is ended. In the present embodiment, the contents of the print setting items are arranged to be outputted to the printer 20. Instead, the PC 10 may be arranged to form print data that reflects the contents of the print setting items and to output the formed print data to the printer 20, whereby the printer 20 may perform printing simply based on the print data.

In the present embodiment, when the fixation level of the ink is changed by the user and it is judged that the “OK” button 34 has been selected (S220: YES), the input of the ink fixation information indicative of the level or degree of the ink fixation property by the user is accepted, and there is determined, as the ink to be used for printing in the printing portion 23 of the printer 20, ink that corresponds to the ink fixation information, i.e., the fixation level set in the fixation-level setting section 40, (S230), specifically based on the ink type or the ink mixing ratio.

### 4. Features of Print System According to First Embodiment

In the first embodiment, the fixation level, i.e., the degree of ink fixation, can be set by the user, whereby the fixation level can be suitably changed depending upon the characteristics of the recording paper to be used, i.e., the paper type or quality. Accordingly, it is possible for the user to obtain a desired print result for any kind of paper to be used.

In the first embodiment, the fixation level can be suitably changed by changing the ink mixing ratio, so that a print result desired by the user can be obtained more easily. Moreover, as the fixation level is indicated in the plurality of level steps in the first embodiment, the user can easily set the fixation level to be adopted in printing. Further, the ink type and the ink mixing ratio are predetermined for each of the plurality of level steps, facilitating the setting of the ink that corresponds to the fixation level.

Even if the user sets the degree of the ink fixation, there may be a possibility that a pint result to be obtained will be undesirable one, depending upon the type of the recording paper to be used, in particular when the OHP film, the glossy paper or the like is designated. In this instance, the user is prohibited to set the ink fixation level according to the first embodiment. Accordingly, it is possible to prevent, in advance, the print result from being deteriorated.

### 5. Relationship Between Elements of Invention and First Embodiment

In the first embodiment, the PC 10 functions as a print control apparatus and the printer 20 functions as a print device. A portion of the PC 10 that executes the processing in S120 and S130 functions as a paper-type identifying portion. A portion of the PC 10 that executes the processing in S160-S190 and S230 functions as an ink determining portion. A portion of the PC 10 that executes the processing in S110 functions as an input-operation-image-displaying control portion. A portion of the PC 10 that executes the processing in S140 and S150 functions as a prohibiting portion.

### Second Embodiment

In the illustrated first embodiment, the fixation level is changed by the use irrespective of the ink color. In the second embodiment, the user can change the fixation level (the mixing ratio of the pigment ink and the dye ink) each for the black ink and the color ink (which collectively refers to the cyan (C) ink, the yellow (Y) ink, and the magenta (M) ink in the present embodiment).

### 1. Outline of Print System

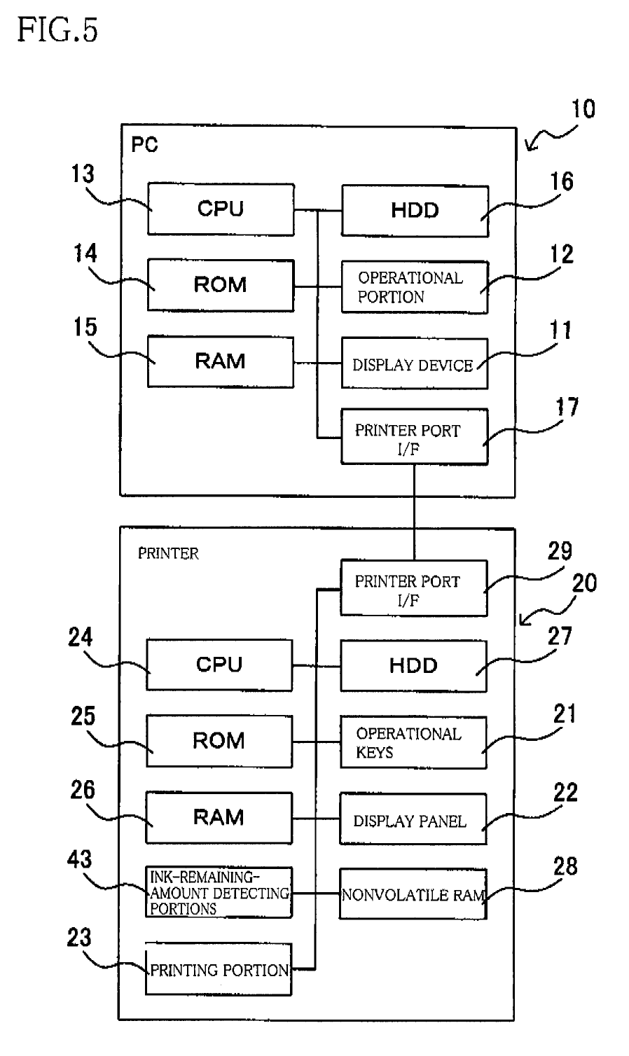

FIG. 5 schematically shows a print system according to the second embodiment. As shown in FIG. 5, the printer 20 in the second embodiment is equipped with ink-remaining-amount detecting portions 43 each of which is for detecting an amount of the ink remaining in the corresponding ink tank and which are provided for the respective ink tanks.

### 2. Print Setting Window

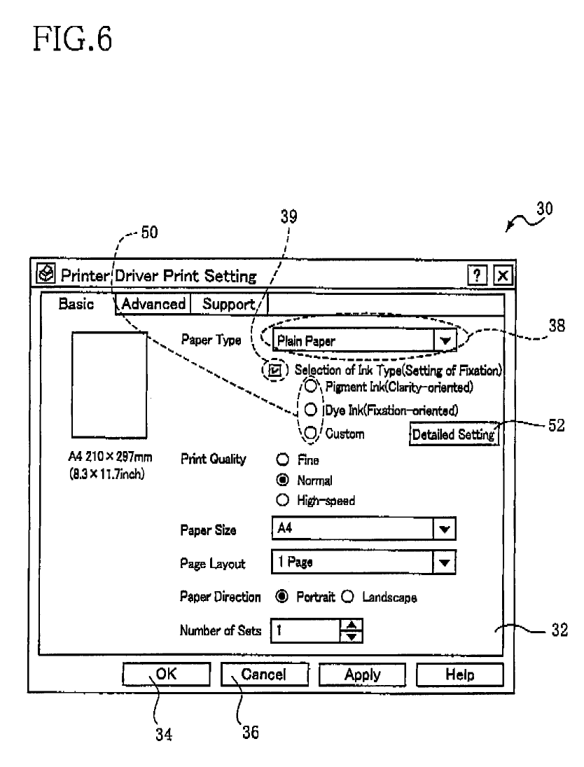

FIG. 6 is an explanatory view of a print setting window 30 (as an input-operation image) according to the second embodiment. In a fixation-level setting section 50 of the print setting window 30, any one of the following three options is selectable by the user's input operation: (1) only pigment ink is used in printing; (2) only dye ink is used in printing; and (3) the user can set the mixing ratio of the pigment ink and the dye ink.

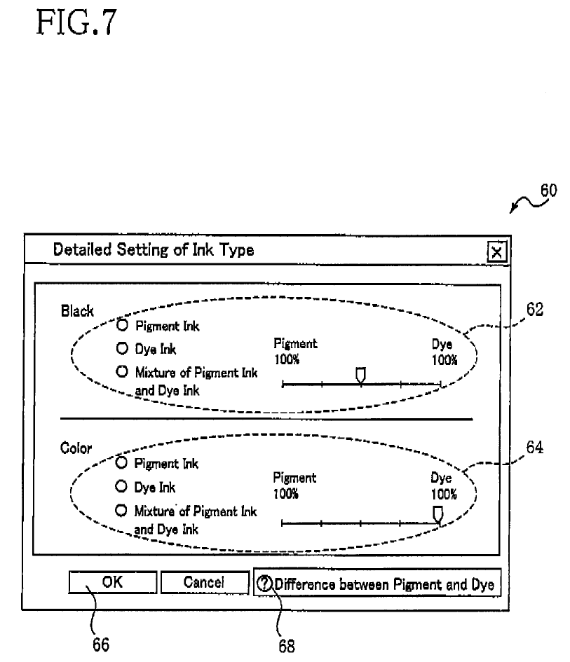

In the fixation-level setting section 50, there is provided a “Detailed Setting” button 52 for permitting the user to perform a detailed setting of the fixation level. The “Detailed Setting” button 52 is arranged to be selectable or clickable when the setting of the mixing ratio by the user is selected, i.e., the above-indicated option (3), in other words, when a check mark is placed on a print setting item indicating “Custom” shown in FIG. 6. When the “Detailed Setting” button 52 is clicked, there is displayed a detailed setting window 60 for the fixation level, as shown in FIG. 7. The detailed setting window 60 as a next input-operation image is for permitting the user to set the mixing ratio of the pigment ink and the dye ink.

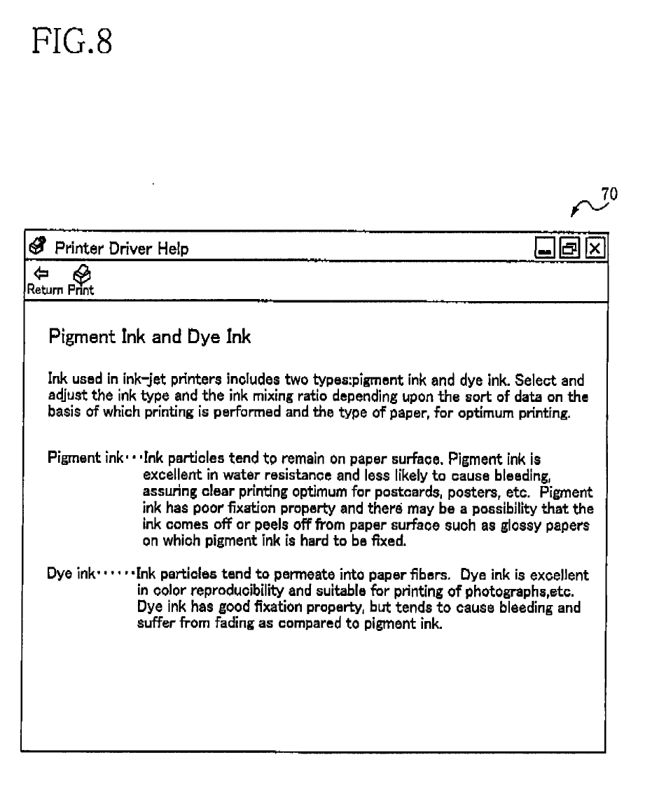

The detailed setting window 60 is arranged such that the fixation level can be set separately for the black ink and the color ink. As shown in FIG. 7, the detailed setting window 60 is constituted by including a black-ink-fixation-level setting section 62, a color-ink-fixation-level setting section 64, an “OK” button 66, and an advice button 68 for displaying an advice window 70 which will be described with reference to FIG. 8.

The black-ink-fixation-level setting section 62 is for changing the fixation level in the black ink. In the black-ink-fixation-level setting section 62, the black ink to be used in printing is selected, by the user's input operation, from among the following three options: (1) the pigment ink only; (2) the dye ink only; and (3) a mixture of the pigment ink and the dye ink (a mixture ink).

Where the mixture of the pigment ink and the dye ink, i.e., the above-indicated option (3) is selected, in other words, where a print setting item indicating the mixture of the pigment ink and the dye ink is selected in the black-ink-fixation-level setting section 62 shown in FIG. 7, the fixation level of the black ink can be set in a plurality of level steps (five level steps in the second embodiment) as in the illustrated first embodiment.

The color-ink-fixation-level setting section 64 is for changing the fixation level in the color ink. In the color-ink-fixation-level setting section 64, the color ink to be used in printing is selected, by the user's input operation, from among the following three options: (1) the pigment ink only; (2) the dye ink only; and (3) a mixture of the pigment ink and the dye ink (a mixture ink).

Where the mixture of the pigment ink and the dye ink, i.e., the above-indicated option (3) is selected, in other words, where a print setting item indicating the mixture of the pigment ink and the dye ink is selected in the color-ink-fixation-level setting section 64 shown in FIG. 7, the fixation level of the color ink can be set in a plurality of level steps (five level steps in the second embodiment) as in the illustrated first embodiment.

As shown in FIG. 8, the advice window 80 indicates comments which offers advice to the user about selection of the fixation level. According to the advice, a difference between the pigment ink and the dye ink is explained. More specifically, the following explanation is given as to the pigment ink. “Pigment ink . . . Ink particles tend to remain on paper surface. Pigment ink is excellent in water resistance and less likely to cause bleeding, assuring clear printing optimum for postcards, posters, etc. Pigment ink has poor fixation property and there may be a possibility that ink comes off or peels off from paper surface such as glossy papers on which pigment ink is hard to be fixed.” Further, the following explanation is given as to the dye ink. “Dye ink . . . Ink particles tend to permeate into paper fibers. Dye ink is excellent in color reproducibility and suitable for printing of photographs, etc. Dye ink has good fixation property, but tends to cause bleeding and suffer from fading as compared to pigment ink.” The advice indicated on the advice window 80 is not limited to that described above. A plurality of windows may be arranged to open for indicating more detailed advice.

### 3. Characteristic Operation of Printer by Execution of Print Control Program

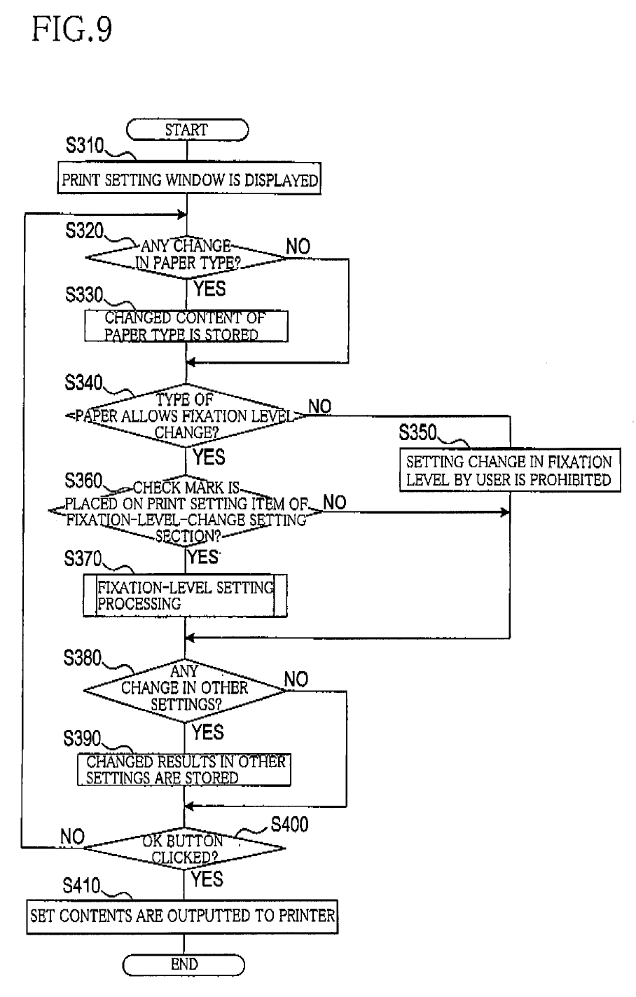

FIG. 9 is a flow chart indicating a characteristic operation of the printer 20 of the second embodiment by execution of a program for controlling the printer 20. This program is normally stored in the HDD 16 and is executed when a print command is inputted by the user's manipulation of the operational portion 12. When the program shown in FIG. 9 is started, the print setting window 30 shown in FIG. 6 is displayed on the display device 11 (S310).

The processing in S320-S360 is substantially identical with the processing in S120-S160 of the flow chart of FIG. 3. The processing in S380-S410 is substantially identical with the processing in S200-S230 of the flow chart of FIG. 3. Accordingly, the processing which is common to the processing in the flow chart of FIG. 3 is not explained, and there will be only explained fixation-level setting processing in S370.

### 3.1. Fixation-Level Setting Processing

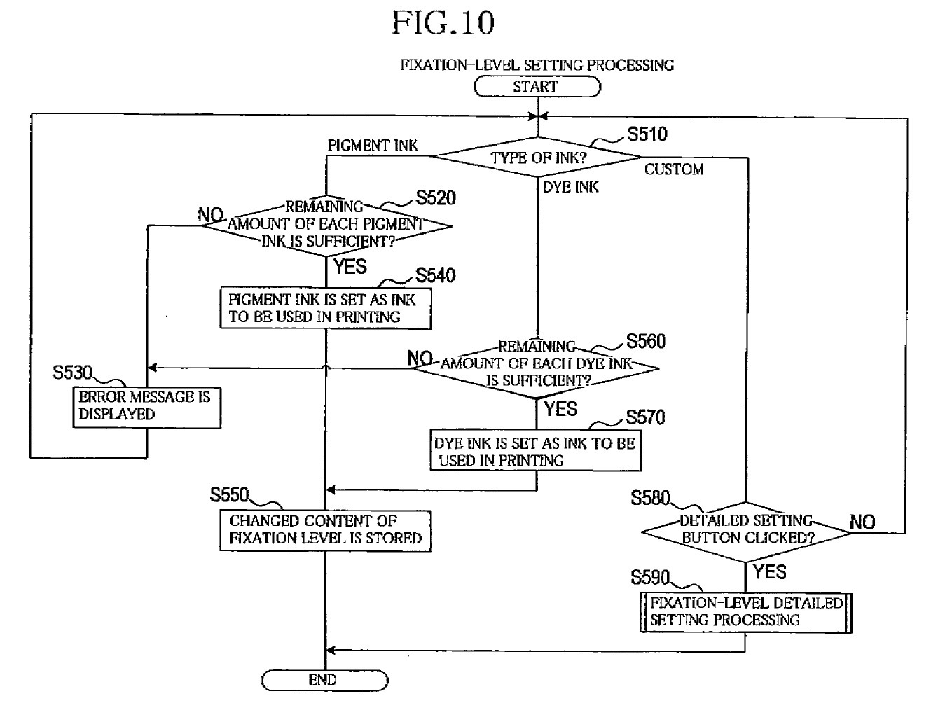

FIG. 10 is a flow chart indicating the fixation-level setting processing (S370 in FIG. 9). The program shown in FIG. 10 is executed when it is judged that the check mark is placed on the print setting item of the fixation-level-change selecting section 39 (S360 in the flow chart of FIG. 9: YES).

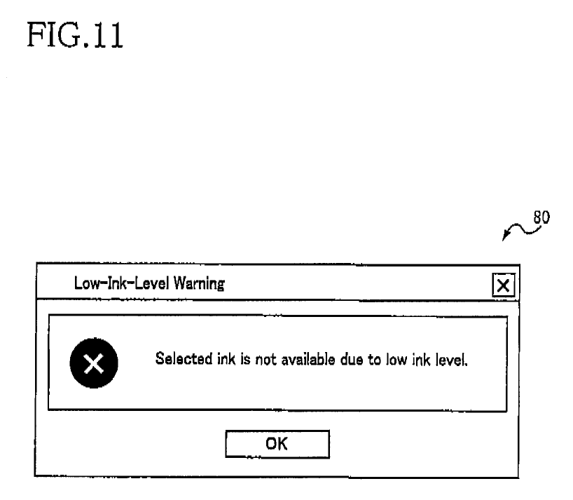

When the fixation-level setting processing is started, it is judged on which one of the print setting items “Pigment Ink”, “Dye Ink”, and “Custom” of the fixation-level setting section 50 (FIG. 6) the check mark is placed (S510).

Where it is judged in S510 that the check mark is placed on the print setting item “Pigment Ink”, there is obtained, from the printer 20, detection results of the ink-remaining-amount detecting portions 43 of the pigment-ink-tank group. Based on the obtained detection results, it is judged whether the remaining amount of each pigment ink is not smaller than a prescribed amount (S520).

Where it is judged in S520 that the remaining amount of at least one of the pigment inks is less than the prescribed amount (S520: NO), it is judged that printing with the pigment ink is not performable. In this instance, there is displayed, on the display device 11, an error message window 80 shown in FIG. 11 indicting that printing with the ink selected by the user is not performable (S530). Then the control flow goes to S510.

On the other hand, where it is judged in S520 that the remaining amount of each pigment ink is not smaller than the prescribed amount (S520: YES), it is judged that printing with the pigment ink is performable. In this instance, the pigment ink is set as the ink to be used in printing (S540), and the result of selection of the pigment ink is stored in the HDD 16 as the default value of the ink fixation level (S550). Thus, the fixation-level-setting processing is ended.

Where it is judged in S510 that the check mark is placed on the print setting item “Dye Ink”, there is obtained, from the printer 20, detection results of the ink-remaining-amount detecting portions 43 of the dye-ink-tank group. Based on the obtained detection results, it is judged whether the remaining amount of each dye ink is not smaller than a prescribed amount (S560).

Where it is judged in S560 that the remaining amount of at least one of the dye inks is less than the prescribed amount (S560: NO), it is judged that printing with the dye ink is not performable. In this instance, there is displayed, on the display device 11, the error message window 80 shown in FIG. 11 indicting that printing with the ink selected by the user is not performable (S530).

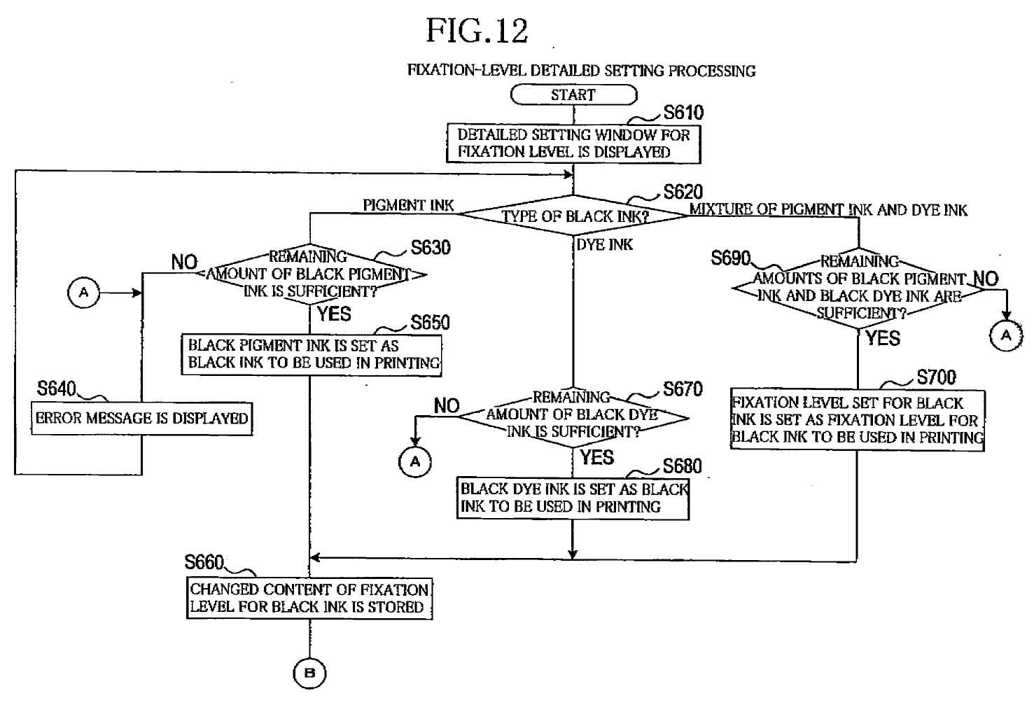

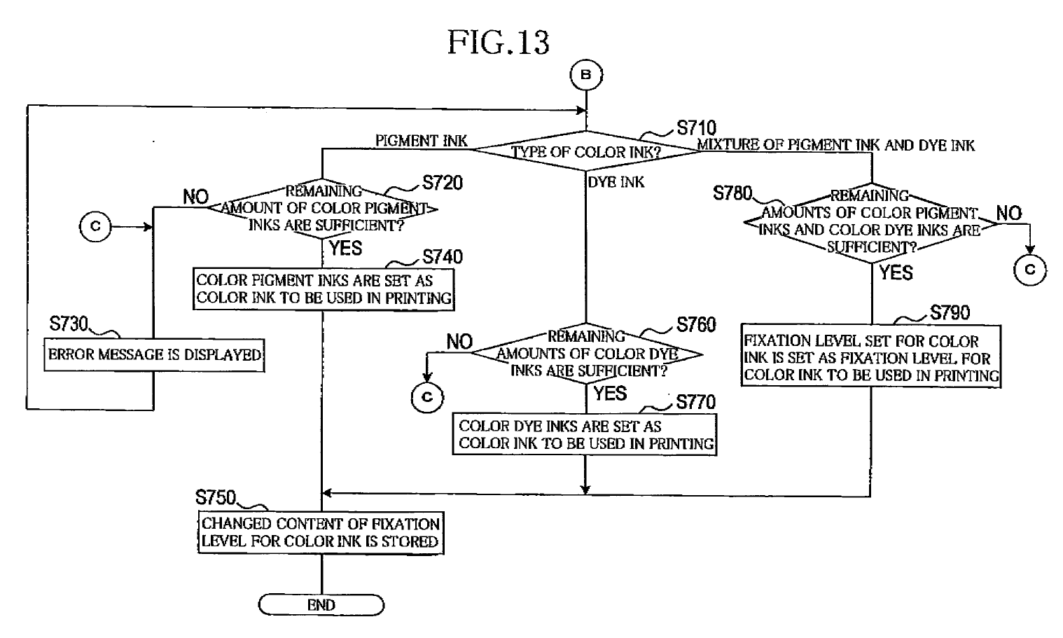

On the other hand, where it is judged in S560 that the remaining amount of each dye ink is not smaller than the prescribed amount (S560: YES), it is judged that printing with the dye ink is performable. In this instance, the dye ink is set as the ink to be used in printing (S570), and the result of selection of the dye ink is stored in the HDD 16 as the default value of the ink fixation level (S550). Thus, the fixation-level-setting processing is ended.

Where it is judged in S510 that the check mark is placed on the print setting item “Custom”, it is judged whether the “Detailed Setting” button 52 has been selected or clicked (S580).

Where it is judged that the “Detailed Setting” button 52 has not been clicked (S580: NO), the control flow goes to S510 and stands by for changes in the print setting items. On the other hand, where it is judged that the “Detailed Setting” button 52 has been clicked (S580: YES), there is executed fixation-level detailed setting processing (which will be described with reference to FIGS. 12 and 13) for permitting the user to set the mixing ratio of the pigment ink and the dye ink, i.e., the fixation level, (S590). Thus, the fixation-level setting processing is ended.

### 3.2. Fixation-Level Detailed Setting Processing

FIGS. 12 and 13 are flow charts showing the fixation-level detailed setting processing (S590 in the flow chart of FIG. 10). When the fixation-level detailed setting processing is started, the detailed setting window 60 for the fixation level shown in FIG. 7 is displayed on the display device 11 (S610).

It is judged on which one of the print setting items “Pigment Ink”, “Dye Ink”, and “Mixture of Pigment Ink and Dye Ink” in the black-ink-fixation-level setting section 62 of the detailed setting window 60 the check mark is placed (S620).

Where it is judged in S620 that the check mark is placed on the print setting item “Pigment Ink”, there is obtained, from the printer 20, a detection result of the ink-remaining-amount detecting portion 43 of the black-pigment-ink tank. Based on the detection result, it is judged whether the remaining amount of the black pigment ink is not smaller than a prescribed amount (S630).

Where it is judged in S630 that the remaining amount of the black pigment ink is less than the prescribed amount (S630: NO), it is judged that printing with the black pigment ink is not performable. In this instance, the error message window 80 shown in FIG. 11 is displayed on the display device 11 (S640), and the control flow goes to S620.

Where it is judged in S630 that the remaining amount of the black pigment ink is not smaller than the prescribed amount (S630: YES), it is judged that printing with the black pigment ink is performable. In this instance, the black pigment ink is set as the black ink to be used in printing (S650), and the result of selection of the black pigment ink is stored in the HDD 16 as the default value of the fixation level for the black ink (S660).

Where it is judged in S620 that the check mark is placed on the print setting item “Dye Ink”, there is obtained, from the printer 20, a detection result of the ink-remaining-amount detecting portion 43 of the black-dye-ink tank. Based on the detection result, it is judged whether the remaining amount of the black dye ink is not smaller than a prescribed amount (S670).

Where it is judged in S670 that the remaining amount of the black dye ink is less than the prescribed amount (S670: NO), it is judged that printing with the black dye ink is not performable. In this instance, the error message window 80 shown in FIG. 11 is displayed on the display device 11 (S640).

Where it is judged in S670 that the remaining amount of the black dye ink is not smaller than the prescribed amount (S670: YES), it is judged that printing with the black dye ink is performable. In this instance, the black dye ink is set as the black ink to be used in printing (S680), and the result of selection of the black dye ink is stored in the HDD 16 as the default value of the fixation level for the black ink (S660).

Where it is judged in S620 that the check mark is placed on the print setting item “Mixture of Pigment Ink and Dye Ink”, there are obtained, from the printer 20, respective detection results of the ink-remaining-amount detecting portions 43 of the black-pigment-ink tank and the black-dye-ink tank. Based on the detection results, it is judged whether the remaining amount of each of the black pigment ink and the black dye ink (hereinafter collectively referred to as “the black ink” where appropriate) is not smaller than a prescribed amount (S690).

Where it is judged in S690 that the remaining amount of at least one of the black pigment ink and the black dye ink is less than the prescribed amount (S690: NO), it is judged that printing with the black ink is not performable. In this instance the error message window 80 shown in FIG. 11 is displayed on the display device 11 (S640). Then the control flow goes to S620.

On the other hand, it is judged in S690 that the remaining amount of each of the black pigment ink and the black dye ink is not smaller than the prescribed amount (S690: YES), it is judged that printing with the black ink is performable, and the fixation level in accordance with the input operation by the user on the black-ink-fixation-level setting section 62 is set as the fixation level for the black ink to be employed in printing (S700). Further, the thus set fixation level is stored in HDD 16 as the default value.

Upon completion of the processing in S660, it is judged on which one of the print setting items “Pigment Ink”, “Dye Ink”, and “Mixture of Pigment Ink and Dye Ink” in the color-ink-fixation-level setting section 64 of the detailed setting window 60 the check mark is placed (S710), as shown in FIG. 13.

Where it is judged in S710 that the check mark is placed on the print setting item “Pigment Ink”, there are obtained, from the printer 20, detection results of the respective ink-remaining-amount detecting portions 43 of the color-pigment-ink (C, Y, M) tanks. Based on the detection results, it is judged whether the remaining amounts of the respective color pigment inks are not smaller than a prescribed amount (S720).

Where it is judged in S720 that the remaining amount of at least one of the color pigment inks is less than the prescribed amount (S720: NO), it is judged that printing with the color pigment inks is not performable. In this instance, the error message window 80 shown in FIG. 11 is displayed on the display device 11 (S730), and the control flow goes to S710.

Where it is judged in S720 that the remaining amounts of the respective color pigment inks are not smaller than the prescribed amount (S720: YES), it is judged that printing with color pigment inks is performable. In this instance, the color pigment inks are set as the color ink to be used in printing (S740), and the result of selection of the color pigment inks is stored in the HDD 16 as the default value of the fixation level for the color ink (S750). Thus, the fixation-level detailed setting processing is ended.

Where it is judged in S710 that the check mark is placed on the print setting item “Dye Ink”, there are obtained, from the printer 20, detection results of the respective ink-remaining-amount detecting portions 43 of the color-dye-ink (C, Y, M) tanks. Based on the detection results, it is judged whether the remaining amounts of the respective color dye inks are not smaller than a prescribed amount (S760).

Where it is judged in S760 that the remaining amount of at least one of the color dye inks is less than the prescribed amount (S760: NO), it is judged that printing with the color dye inks is not performable. In this instance, the error message window 80 shown in FIG. 11 is displayed on the display device 11 (S730).

Where it is judged in S760 that the remaining amounts of the respective color dye inks are not smaller than the prescribed amount (S760: YES), it is judged that printing with the color dye inks is performable. In this instance, the color dye inks are set as the color ink to be used in printing (S770), and the result of selection of the color dye inks is stored in the HDD 16 as the default value of the fixation level for the color ink (S770). Thus, the fixation-level detailed setting processing is ended.

Where it is judged in S710 that the check mark is placed on the print setting item “Mixture of Pigment Ink and Dye Ink”, there are obtained, from the printer 20, detection results of the ink-remaining-amount detecting portions 43 of the color-pigment-ink tanks and the color-dye-ink tanks. Based on the detection results, it is judged whether the remaining amounts of the respective color pigment inks and the remaining amounts of the respective color dye inks (hereinafter collectively referred to as “the color inks” where appropriate) are not smaller than a prescribed amount (S780).

Where it is judged in S780 that the remaining amount of at least one of the color inks is less than the prescribed amount (S780: NO), it is judged that printing with the color inks is not performable, and the error message shown in FIG. 11 is displayed on the display device 11 (S730).

Where it is judged in S780 that the remaining amounts of the respective color inks are not smaller than the prescribed amount (S780: YES), it is judged that printing with the color inks is performable. In this instance, the fixation level in accordance with the input operation by the user on the color-ink-fixation-level setting section 64 is set as the fixation level for the color ink to be used in printing (S790), and the thus set fixation level is stored in the HDD 16 as the default value (S750). Thus, the fixation-level detailed setting processing is ended.

4. Features of Print System according to Second Embodiment

As in the first embodiment, in the second embodiment, the fixation level, i.e., the degree of ink fixation, can be set by the user, whereby the fixation level can be suitably changed depending upon the characteristics of the recording paper to be used, i.e., the paper type or quality. Accordingly, it is possible for the user to obtain a desired print result for any kind of paper to be used.

In the second embodiment, the ink to be used in printing can be set simply by selecting one of the three print setting items (options) indicated on the fixation-level setting section 50 (shown in FIG. 6) that is desired by the user, whereby operability or usability of the print system can be improved. Where the mixing ratio of the pigment ink and the dye ink is set or selected by the user, it is possible to more suitably satisfy the user's demand.

In the second embodiment, the fixation level can be set individually for the black ink and the color ink, thereby permitting a print result desired by the user to be obtained by simple selecting operations. Where the user selects the mixture of the pigment ink and the dye ink, the mixing ratio of the pigment ink and the dye ink can be set individually for the black ink and the color ink, making it possible to more suitably satisfy the user's demand. That is, the fixation level can be suitably changed by changing the ink mixing ratio, so that a print result desired by the user can be obtained more easily.

In the second embodiment, if the user does not know the ink fixation well, he/she can refer to the advice window 70 (shown in FIG. 8) that is displayed on the display device 11, for information on the pigment ink and the dye ink to select the degree of the ink fixation, i.e., the fixation level. Accordingly, the usability of the print system can be improved.

In the second embodiment, when printing with ink whose fixation level is set by the user is not performable due to a low ink level, i.e., due to a shortage of the ink remaining amount, the low-ink-level warning is displayed to notify the user of the fact that printing is not performable. In this instance, the user can take measures such as changing the ink fixation level before printing. Accordingly, the present arrangement obviates an occurrence of a trouble or error that printing cannot be performed normally due to the ink shortage even though the ink to be used is set on the basis of the user's selection.

In the second embodiment, the low-ink-level warning is displayed to notify the user of the low level of the remaining ink. Instead, the user may be notified of the low level of the remaining ink by voice, for instance.

Even if the user sets the degree of the ink fixation, there may be a possibility that a pint result to be obtained will be undesirable one, depending upon the type of the recording paper to be used, in particular when the OHP film, the glossy paper or the like is designated. In this instance, the user is prohibited to set the ink fixation level according to the second embodiment. Accordingly, it is possible to prevent, in advance, the print result from being deteriorated.

### 5. Relationship Between Elements of Invention and Second Embodiment

In the second embodiment, the PC 10 functions as a print control apparatus and the printer 20 functions as a print device. A portion of the PC 10 that executes the processing in S320 and S330 functions as a paper-type identifying portion. A portion of the PC 10 that executes the processing in S360, S370, and S410 functions as an ink determining portion. A portion of the PC 10 that executes the processing in S310 and S610 functions as an input-operation-image-displaying control portion. A portion of the PC 10 that executes the processing in S340 and S350 functions as a prohibiting portion.

Further, a portion of the PC 10 that executes the processing in S520, S560, S630, S670, S690, S720, S760, and S780 functions as a judging portion. A portion of the PC 10 that executes the processing in S530, S640, and S730 functions as a notifying portion. A portion of the PC 10 that executes the processing of displaying the advice window 70 functions as an advice-displaying control portion.

### Other Embodiments

While the ink fixation level is arranged to be changed in steps in the illustrated embodiments, the ink fixation level may be arranged to be changed continuously or steplessly.

In the illustrated second embodiment, when it is judged that the remaining amount of the black ink, namely, the remaining amount of at least one of the black pigment ink and the black dye ink, is less than the prescribed amount, it is judged that printing with the black ink is not performable and the error message window 80 is displayed. In this respect, when the remaining amounts of the black pigment ink and the black dye ink are individually detected, there may be cases where the remaining amount of one of the black pigment ink and the black dye ink is small while the remaining amount of the other of the black pigment ink and the black dye ink is large. In such cases, the print system may be arranged to prohibit the mixing ratio from being set such that the ink whose remaining amount is small is consumed more.

While the selection of the type of the recording paper, the setting of the ink fixation level, etc., are performed on the part of the PC 10 in the illustrated embodiments, such selection and setting may be performed on the part of the printer 20.

The illustrated embodiments relate to the print system in which the PC 10 functions as a print control apparatus and the printer 20 functions as a print device. The print system may be configured such that the print device is equipped with the print control apparatus. That is, the printer per se may function as the print system indicated above. In this instance, a control apparatus such as a computer incorporated in the printer functions as the above-indicated print control apparatus. Further, a display provided on an operation panel of the printer may function as a display device which displays the above-indicated print setting window and so on.

Where the pigment ink and the dye ink are mixed, the pigment ink and the dye ink may be mixed in advance and then ejected toward the recording paper. Alternatively, the pigment ink and the dye ink being ejected separately may be mixed with each other on the recording paper.

It is to be understood that the invention is not limited to the details of the illustrated embodiments, but may be embodied with various changes and modifications, which may occur to those skilled in the art, without departing from the spirit and scope of the invention defined in the attached claims.

What is claimed is:

1. A print control apparatus which is connected to a print device for printing an image by fixing ink on a recording paper and which controls the print device, comprising:
a paper-type identifying portion which identifies a type of the recording paper on which the print device prints the image, on the basis of at least one of an input operation by an operator and pre-set contents; and
an ink determining portion which determines ink to be used by the print device in order to print the image on the recording paper that is identified by the paper-type identifying portion, on the basis of ink fixation information which indicates a level of ink fixation and which is inputted by the input operation by the operator.

2. The print control apparatus according to claim 1,
wherein the print device is configured to perform printing by using a plurality of inks having mutually different levels of the ink fixation, and
wherein the ink determining portion determines, as the ink to be used in printing by the print device, a mixture ink in which the plurality of inks are to be mixed at a mixing ratio that is based on the ink fixation information.

3. The print control apparatus according to claim 1,
wherein the print device is configured to perform color printing with a plurality of colors including a black color and another color that is different from the black color, by using, for each of the black color and the another color, a plurality of inks having mutually different levels of the ink fixation, and
wherein the ink determining portion determines, for each of the black color and the another color, a mixture ink as the ink to be used in printing by the print device, the mixture ink being obtained by mixing the plurality of inks at a mixing ratio that is based on the ink fixation information inputted for each of the black color and the another color.

4. The print control apparatus according to claim 1, further comprising an input-operation-image-displaying control portion operable to control a display device to display an input-operation image through which the operator inputs the ink fixation information,
wherein the input-operation image indicates the level of the ink fixation in a plurality of level steps such that the operator can select one of the plurality of level steps as the ink fixation information, and
wherein the ink determining portion determines, as the ink to be used in printing by the print device, ink corresponding to the one of the plurality of level steps selected through the input-operation image by the operator.

5. The print control apparatus according to claim 1,
wherein the print device is configured to perform printing with at least one of a pigment ink and a dye ink,
wherein the print control apparatus further comprises an input-operation-image-displaying control portion operable to control a display device to display an input-operation image through which the operator inputs the ink fixation information,
wherein the input-operation image is displayed such that the operator can select, as the ink fixation information, one of: an ink type that is employed when the print device performs printing with one of the pigment ink and the dye ink; and a mixing ratio of the pigment ink and the dye ink in a mixture ink when the print device performs printing with the mixture ink in which the pigment ink and the dye ink are to be mixed, and
wherein the ink determining portion determines, as the ink to be used in printing by the print device, one of: (A) one of the pigment ink and the dye ink that corresponds to the ink type selected by the operator through the input-operation image; and (B) the mixture ink having the mixing ratio selected by the operator through the input-operation image.

6. The print control apparatus according to claim 1,
wherein the print device is configured to perform color printing with a plurality of colors including a black color and another color that is different from the black color, by using, for each of the black color and the another color, at least one of a pigment ink and a dye ink,
wherein the print control apparatus further comprises an input-operation-image-displaying control portion operable to control a display device to display an input-operation image through which the operator inputs the ink fixation information for each of the black color and the another color,
wherein the input-operation image is displayed such that the operator can select for each of the black color and the another color, as the ink fixation information, one of: an ink type that is employed when the print device performs printing with one of the pigment ink and the dye ink; and a mixing ratio of the pigment ink and the dye ink in a mixture ink when the print device performs printing with the mixture ink in which the pigment ink and the dye ink are to be mixed, and
wherein the ink determining portion determines, for each of the black color and the another color, as the ink to be used in printing by the print device, one of: (A) one of the pigment ink and the dye ink that corresponds to the ink type selected by the operator through the input-operation image; and (B) the mixture ink having the mixing ratio selected by the operator through the input-operation image.

7. The print control apparatus according to claim 1, further comprising a prohibiting portion which prohibits processing by the ink determining portion when the type of the recording paper identified by the paper-type identifying portion is a predetermined type.

8. The print control apparatus according of claim 1, further comprising an advice-displaying control portion operable to control a display device to display comments including advice relating to the ink fixation.

9. The print control apparatus according to claim 1, further comprising: a judging portion which judges whether it is possible to perform printing with the ink determined by the ink determining portion as the ink to be used in printing by the print device, on the basis of a remaining amount of the ink; and a notifying portion which notifies the operator that it is impossible to perform printing with the ink when the judging portion judges that it is impossible to perform printing with the ink.

10. The print control apparatus according to claim 1, which is incorporated in the print device.

11. A print system comprising a print device which prints an image by fixing ink on a recording paper and a print control apparatus which controls the print device,
wherein the print control apparatus includes: (a) a paper-type identifying portion which identifies a type of the recording paper on which the print device prints the image, on the basis of at least one of an input operation by an operator and pre-set contents; and (b) an ink determining portion which determines ink to be used by the print device in order to print the image on the recording paper that is identified by the paper-type identifying portion, on the basis of ink fixation information which indicates a level of ink fixation and which is inputted by the input operation by the operator.

12. The print system according to claim 11, wherein the print control apparatus is installed on the print device.

13. A print system comprising a print device which prints an image by fixing ink on a recording paper and the print control apparatus defined in claim 1 as a print control apparatus which controls the print device.

14. A computer-readable recording medium containing a print control program for controlling a print device which prints an image by fixing ink on a recording paper, the print control program causing a computer to function such that the computer includes:
a paper-type identifying portion which identifies a type of the recording paper on which the print device prints the image, on the basis of at least one of an input operation by an operator and pre-set contents; and
an ink determining portion which determines ink to be used by the print device in order to print the image on the recording paper that is identified by the paper-type identifying portion, on the basis of ink fixation information which indicates a level of ink fixation and which is inputted by the input operation by the operator.

15. The computer-readable recording medium according to claim 14,
wherein the print device is configured to perform printing by using a plurality of inks having mutually different levels of the ink fixation, and
wherein the ink determining portion determines, as the ink to be used in printing by the print device, a mixture ink in which the plurality of inks are to be mixed at a mixing ratio that is based on the ink fixation information.

16. The computer-readable recording medium according to claim 14,
wherein the print device is configured to perform color printing with a plurality of colors including a black color and another color that is different from the black color, by using, for each of the black color and the another color, a plurality of inks having mutually different levels of the ink fixation, and
wherein the ink determining portion determines, for each of the black color and the another color, a mixture ink as the ink to be used in printing by the print device, the mixture ink being obtained by mixing the plurality of inks at a mixing ratio that is based on the ink fixation information inputted for each of the black color and the another color.

17. The computer-readable recording medium according to claim 14,
wherein the print control program causes the computer to function such that the computer further includes an input-operation-image-displaying control portion operable to control a display device to display an input-operation image through which the operator inputs the ink fixation information,
wherein the input-operation image indicates the level of the ink fixation in a plurality of level steps such that the operator can select one of the plurality of level steps as the ink fixation information, and
wherein the ink determining portion determines, as the ink to be used in printing by the print device, ink corresponding to the one of the plurality of level steps selected through the input-operation image by the operator.

18. The computer-readable recording medium according to claim 14,
wherein the print device is configured to perform printing with at least one of a pigment ink and a dye ink,
wherein the print control program causes the computer to function such that the computer further includes an input-operation-image-displaying control portion operable to control a display device to display an input-operation image through which the operator inputs the ink fixation information,
wherein the input-operation image is displayed such that the operator can select, as the ink fixation information, one of: an ink type that is employed when the print device performs printing with one of the pigment ink and the dye ink; and a mixing ratio of the pigment ink and the dye ink in a mixture ink when the print device performs printing with the mixture ink in which the pigment ink and the dye ink are to be mixed, and
wherein the ink determining portion determines, as the ink to be used in printing by the print device, one of: (A) one of the pigment ink and the dye ink that corresponds to the ink type selected by the operator through the input-operation image; and (B) the mixture ink having the mixing ratio selected by the operator through the input-operation image.

19. The computer-readable recording medium according to claim 14,
wherein the print device is configured to perform color printing with a plurality of colors including a black color and another color that is different from the black color, by using, for each of the black color and the another color, at least one of a pigment ink and a dye ink,
wherein the print control program causes the computer to function such that the computer further includes an input-operation-image-displaying control portion operable to control a display device to display an input-operation image through which the operator inputs the ink fixation information for each of the black color and the another color,
wherein the input-operation image is displayed such that the operator can select for each of the black color and the another color, as the ink fixation information, one of: an ink type that is employed when the print device performs printing with one of the pigment ink and the dye ink; and a mixing ratio of the pigment ink and the dye ink in a mixture ink when the print device performs printing with the mixture ink in which the pigment ink and the dye ink are to be mixed, and
wherein the ink determining portion determines, for each of the black color and the another color, as the ink to be used in printing by the print device, one of: (A) one of the pigment ink and the dye ink that corresponds to the ink type selected by the operator through the input-operation image; and (B) the mixture ink having the mixing ratio selected by the operator through the input-operation image.

20. The computer-readable recording medium according to claim 14, wherein the print control program causes the computer to function such that the computer further includes a prohibiting portion which prohibits processing by the ink determining portion when the type of the recording paper identified by the paper-type identifying portion is a predetermined type.

21. The computer-readable recording medium according to claim 14, the print control program causes the computer to function such that the computer further includes an advice-displaying control portion operable to control a display device to display comments including advice relating to the ink fixation.

22. The computer-readable recording medium according to claim 14, wherein the print control program causes the computer to function such that the computer further includes: a judging portion which judges whether it is possible to perform printing with the ink determined by the ink determining portion as the ink to be used in printing by the print device, on the basis of a remaining amount of the ink; and a notifying portion which notifies the operator that it is impossible to perform printing with the ink when the judging portion judges that it is impossible to perform printing with the ink.

23. A computer-readable recording medium containing a print control program for controlling a print device which prints an image by fixing ink on a recording paper,
wherein the print control program causes a computer to function as the print control apparatus defined in claim 1.
